(19) United States
(12) Patent Application Publication
(10) Pub. No.: US 2007/0223464 A1
(43) Pub. Date: Sep. 27, 2007

(54) Method for the Synchronization of Media Gateways in an IP Network

(76) Inventors: Alan Weir, Libertyville, IL (US); Stephen Moore, Grayslake, IL (US); Andrew McCartney, Libertyville, IL (US); John Blasko, Gurnee, IL (US)

Correspondence Address: MILTON S. GERSTEIN;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/690,223

(22) Filed: Mar. 23, 2007

Related U.S. Application Data
(60) Provisional application No. 60/786,174, filed on Mar. 27, 2006.

(51) Int. Cl. H04L 12/66

(52) U.S. Cl. 370/356

(57) ABSTRACT

A method of providing synchronization of the clocks of all of the media gateways of an Ethernet, or equivalent, IP network used in the transmission of audio data between media gateways using a clock provided by the PSTN. The selection of one of the media gateways connected to the PSTN, termed the master CoHub (Central Office Hub), is used as a clock master. This CoHub derives its clock from its TDM-interface's frame-synchronization with the PSTN to which it is connected. Utilizing this gateway-synchronization method, all MG's are synchronized to this PSTN clock-source.

### CROSS REFERENCE TO RELATED APPLICATION

Priority of provisional application Ser. No. 60/786,174, filed on Mar. 27, 2006 is claimed.

### BACKGROUND OF THE INVENTION

The present invention is directed to the transmission of the audio packets from a PSTN over an IP network. Typically, each media gateway (MG) in an IP network digitizes the desired audio material and sends it to a destination MG on the network. The destination MG receives these packets and ultimately converts them back into audio. When converting the audio material from analog to digital, a clock is required to sample the audio at a fixed rate. In turn, the destination MG that converts the digital back into audio utilizes a similar clock. If these clocks are not synchronized, the source MG will produce more data than the destination MG is prepared to handle, or it may not produce enough data for the destination MG. The effects of these overruns and underruns are negligible for voice conversations, but may be significant in applications where data-modem traffic is being transported. In order to provide high quality voice and highly-reliable data-modem support, media gateways must be able to synchronize clocks between themselves. A method to perform such synchronization is not provided by the Ethernet networks to which the MG's are connected.

### SUMMARY OF THE INVENTION

It is the primary objective of the present invention to provide synchronization of the clocks of all of the media gateways of an Ethernet, or equivalent, IP network used in the transmission of audio data between the gateways.

It is, also, the primary objective of the present invention to provide for such synchronization to a single clock such as that provided by the PSTN.

In accordance with the method of the present invention, selection of one of the media gateways connected to the PSTN, termed the CoHub (Central Office Hub), is used as a clock master. This CoHub derives its clock from its TDM-interface's frame-synchronization with the PSTN to which it is connected. Utilizing this gateway-synchronization method, all MG's are synchronized to this PSTN clock-source. The algorithm used for synchronizing the clock of each media gateway produces an Adjust Factor (AF) value for writing to an Adjust Register of a conventional Field Programmable Gate Array, which Adjust Factor (AF) value is determined according to the following algorithm:

$$AF = \frac{NFS}{128} ,$$

where NFS is the Number of Frame Synchronizations before correction defined by

$$NFS = \frac{T \times 8000}{D} ,$$

where D is the difference between the reference count and the current count, and where T is the time between the reference count and the current count. In a preferred embodiment, AF=Interval*PSPPS/delta, where, Interval=number of seconds elapsed between when the current and baseline averages were computed, and PSPPS=packet sync pulses per second, a constant, and Delta=absolute value of the difference between the current and baseline averages.

### BRIEF DESCRIPTION OF THE DRAWING

The invention will be more readily understood with reference to the accompanying drawing, wherein:

FIG. 1 is a block diagram of an IP network connected to a PSTN via a CoHub media gateway deriving synchronizing clock-source from its TDM-interface connection with the PSTN in order to synchronize all of the MG's of the IP network that are used for transmitting audio data;

FIG. 2 is a logical schematic diagram for implementing the FPGA of the media gateway according to the preferred embodiment of the invention; and

FIG. 3 is a state diagram of a slave media gateway in accordance with the invention.

### DETAILED DESCRIPTION OF THE INVENTION

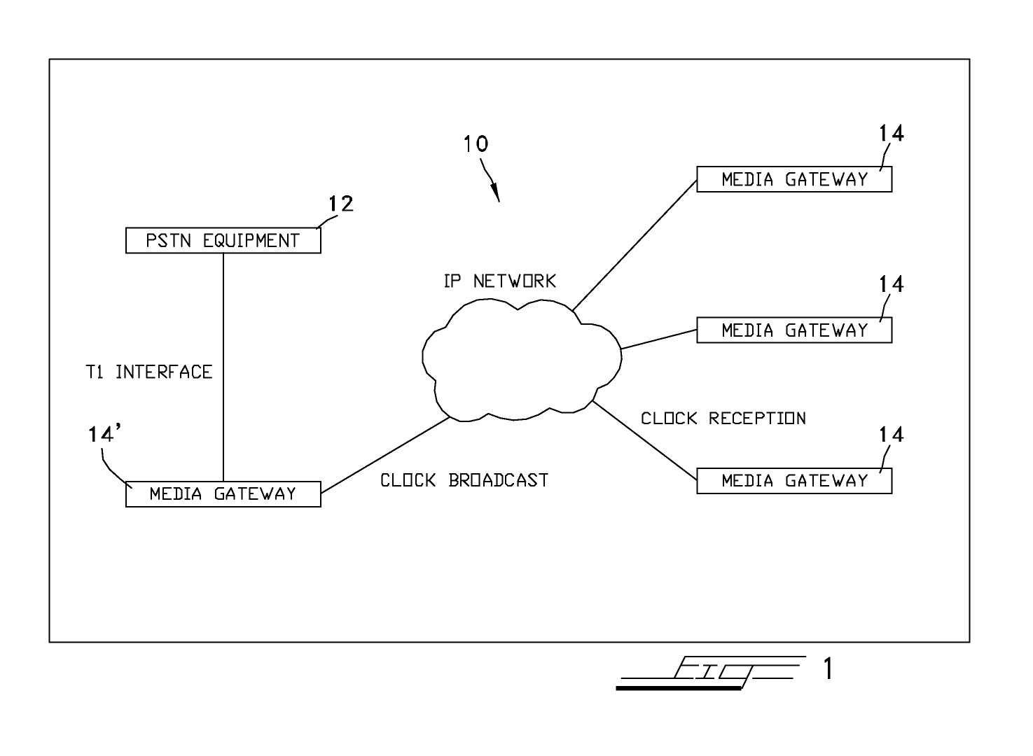

Referring to FIG. 1, there is shown an IP network 10, such as an Ethernet or equivalent network, used in the transmission of audio data packets from a PSTN 12. The IP network consists of a series of media gateways (MG's) 14, with one media gateway 14′ being connected to the PSTN equipment 12 via a conventional TDM (Time Division Multiplexing) interface, such as T1, E1, and equivalents. In accordance with the present invention, and as described in detail hereinbelow, the clock source for synchronizing all of the MG's is derived from the PSTN 12 via the TDM-interface connection with the MG 14′, termed the CoHub (Central Office Hub) MG. This CoHub 14′ uses the PSTN clock source from the PSTN to generate a master clock signal. The clock signal is distributed to every MG on the LAN utilizing IP multicast or unicast. This synchronizes all of one master clock derived from the PSTN. The master MG CoHub 14′ transmits a network synchronization packet once every second, with all other MG's (termed “slave” MG's) in the network receiving the network synchorization packet each second. Each slave MG 14 counts the number of internally generated frame synchronization pulses over the period of time marked by the network synchronization packet. It then determines if its internal clock is running fast or slow with respect to that of the master clock, as described in detail hereinbelow.

The invention is scalable through the use of low-frequency network synchronization packets and the utilization of IP networks to efficiently distribute those packets. It is also capable of being configured with multiple synchronization groups when deployed in a multiple PSTN connection environment. For example, a company that spans two geographic locations can synchronize site 1 gateways to a CoHub located at site 1 and synchronize site 2 gateways to a CoHub at site 2. In any case, the master CoHub MG connected to the PSTN derives a clock with Stratum 4 accuracy directly from the frame synchronization.

The MG adjustment mechanism that allows the method of the invention to be carried out will now be described. Each slave MG provides a mechanism to make small adjustments to its clock in order to match its clock to that of the master CoHub. Each receiving endpoint MG contains a conventional Field Programmable Gate Array (FPGA), such as that made by Xilinx, Inc. FPGA, is a conventional gate array where the logic can be programmed into the device, and consists of an array of logic elements, gates or lookup table RAM's, flip-flops and programmable interconnect wiring. The FPGA is programmed with circuitry to add or steal one source clock cycle, such as a 32.768 MHz clock, to or from the divider that generates the internal 8 kHz PCM frame synchronization pulse. Conventional Pulse Code Modulation (PCM) is a way of acquiring data in one location, converting the data samples to digital words, encoding the data in a serial digital format, and transmitting it to another location for decoding and analysis. The FPGA also has logic to count the pulses, modulo 8000. The 32.768 MHz clock is divided by 128 to drive an Adjustment Counter and by 4096 to produce the frame synchronization. When the Adjustment Counter reaches zero, it is reloaded from an Adjustment Register (written to by the MG's CPU) and a flag is set indicating that the frame synchronization divider is to be adjusted. This adjustment takes place immediately following the generation of the next frame synchronization pulse. The adjustment causes the frame synchronization divider to count 4095 (speed up) or 4097 (slow down) clocks before producing the next frame synchronization pulse. The direction (up or down) is controlled by a bit in the FPGA Control Register as is the overall enabling of this feature.

When the slave MG begins the synchronization process, it does so by recording the value of the frame synchronization counter immediately following the reception of a synchronization packet. Each subsequent synchronization packet causes the endpoint to read the frame synchronization counter and compare the current value to that originally recorded. If the endpoint was in perfect synchronization with the master CoHub then the two values would be identical and remain so over time. If the endpoint clock is faster or slower than the master CoHub, then the two readings will begin to differ over time. If the difference reaches 160, then a complete 20 mS packet will have been lost (one end over producing and the other end under producing). Thus, by choosing a threshold at which one may be certain that the difference between the actual and expected count is a result of clock error and not network latency, one may regulate the clock accordingly. Readings may be averaged over a reasonably long period of time (240 seconds) to eliminate the effects of network jitter and packet loss.

The adjustment calculation is according to the following algorithm. The time between the reference count and the current count is T, and the difference between the reference count and the current count is D. If D is negative the clock needs to be sped up and D=|D|−1:Number of Frame Syncs, before correction,

$$NFS = \frac{T \times 8000}{D}$$

difference; Adjust Factor

$$AF = \frac{NFS}{128} ,$$

and this value (AF) is written to the Adjust Register.

The continued monitoring of the clock is achieved by accumulating a new reference value every two hours, for example. If the difference between the current and reference values exceeds 20 within the two hour period, then recalibration will be conducted.

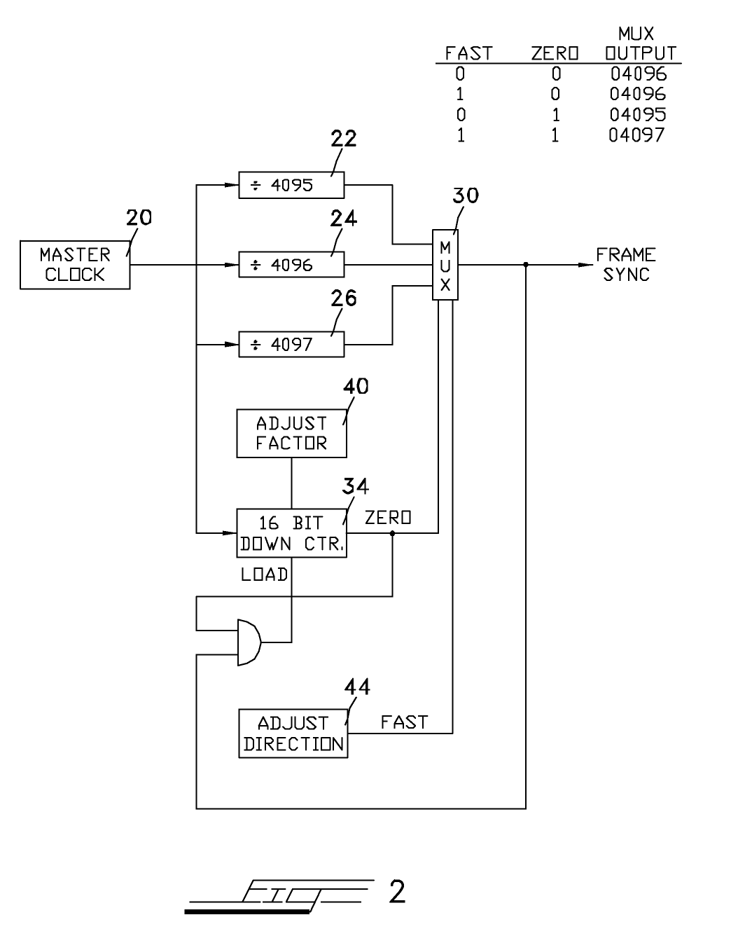

The following description, in association with FIG. 2, is the logic implemented in the FPGA of an MG serving as a master MG according to the preferred embodiment of the invention.

The Master Clock (block 20) is presented to three free running dividers: Divide by 4095-D4095 (block 22); Divide by 4096-D4096 (block 24); and Divide by 4097-D4097 (block 26). The output of each divider is a one clock wide pulse delivered to MUX 30 that selects which divider output will be used for the Frame Sync Signal.

The Master Clock 20 also drives a 16 bit down counter (block 34). This counter is loaded from the ADJUST FACTOR register (block 40) and will count down to zero. Once the counter decrements to zero, the counter stops and the ZERO signal is asserted. The ZERO signal in conjunction with the FAST bit from the ADJUST DIRECTION register (block 44) control the MUX as shown in the table of FIG. 2. The down counter, having reached zero, will be reloaded when the next FRAME SYNC pulse is generated. Thus the time between FRAME SYNC pulses can be stretched or shrunk by one Master Clock cycle every 1 to 65636 clock cycles as controlled by the ADJUST FACTOR value.

The following is a description of how the ARM processor of the synchronization algorithm works. Each Media Gateway (MG) in the system is configured to be either a clock master that generates the clock if it connected to a PSTN, or a clock slave that synchronizes to a clock master. If IP multicast is used to distribute the clock synchronization information, then each MG in the system is configured with a multicast IP address. MGs that are clock masters send clock synchronization information to this multicast address. MGs that are clock slaves receive clock synchronization information at this multicast address. If IP unicast is used to distribute the clock synchronization information, then the clock master MG is configured with this address and sends clock synchronization information to this address. Clock master and clock slave MGs are configured with a UDP port number. Clock master MGs send clock synchronization information to this UDP port. Clock slave MGs receive clock synchronization information on this port. The FPGA generates a periodic interrupt every 40 frame syncs to the MG CPU. On the CoHub, the clock that governs the timing of this interrupt is derived from the connected TDM interface. This interrupt is handled at the highest priority possible in the MG CPU to minimize interrupt latency. The FPGA also contains a register that counts the number of packet sync interrupts, modulo 8000. This register is referred to as the packet sync counter. This register is read only to the MG CPU. The MG CPU contains a free running counter implemented in hardware that automatically increments every 250 microseconds. This register is referred to as the timer register. This register is read only to the MG CPU.

Both clock master and clock slave MGs count the packet sync interrupts. Every second, as determined by the interrupt count, the clock master MG sends a Real Time Protocol (RTP) packet to the configured IP address and UDP port. The RTP packets conform to RFC 3550 and contain valid RTP sequence numbers, timestamps and synchronization source identifiers. The RTP payload type is fixed at G.711 and the RTP payload consists of zeroes. The RTP sequence number and timestamp are updated each time an RTP packet is sent. The clock master MG also records the value of the timer register when it sends the RTP packet. Before sending the next RTP packet, the clock master MG computes the difference between the current value of the timer register and the value of the timer register when it sent the last RTP packet. If the difference is greater than or equal to 2 milliseconds, it is deemed to be too late to send the RTP packet. The RTP sequence number and timestamp are updated but the RTP packet is not sent. To the clock slave MGs, it appears that an RTP packet has been lost. If the connected TDM interface is down, the clock master MG updates the RTP sequence number and timestamp but does not send an RTP packet. To the clock slave MGs, it appears that an RTP packet has been lost.

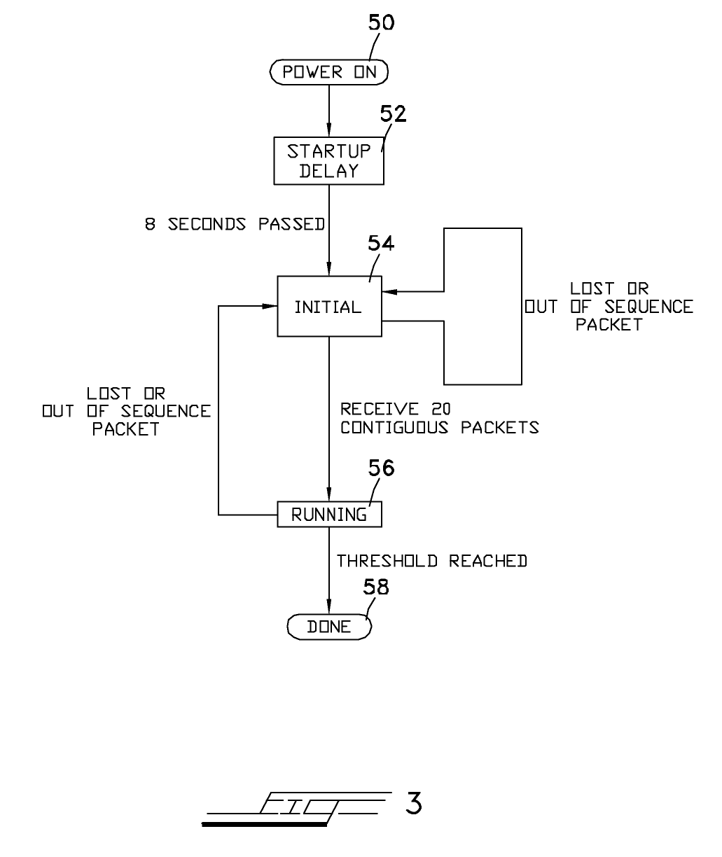

The clock slave-MG contains a state machine described by the state diagram shown in FIG. 3. At power on (block 50), the clock slave-MG enters the “Startup Delay” state (block 52). The clock slave-MG transitions to the “Initial” state after 8 seconds have passed (block 54), as determined by the count of packet sync interrupts. This allows the clock slave-MG to finish all initialization tasks after powering up. Upon entering the “Initial” state, the clock slave-MG begins receiving RTP packets that contain clock synchronization information from the clock master-MG. The clock slave-MG records the value of the packet sync counter when each RTP packet is received. Once 20 contiguous RTP packets have been received, the clock slave-MG computes the average of the values of the packet sync counter and moves to the “Running” state (block 56). This average is referred to as the baseline average. The clock slave-MG uses the RTP timestamp to detect noncontiguous, that is, lost or out of sequence RTP packets. If a noncontiguous RTP packet is detected in the “Initial” state, the clock slave MG discards all packet sync counter readings and reenters the “Initial” state.

Once in the “Running” state, the clock slave-MG continues to receive RTP packets that contain clock synchronization information from the clock master-MG. The clock slave MG continues to record the value of the packet sync counter when each RTP packet is received. Once 20 contiguous RTP packets have been received, the clock slave-MG computes the average of the values of the packet sync counter. This average is referred to as the current average. The clock slave-MG computes an adjustment factor based upon the difference of the baseline and current averages, using the algorithm described hereinbelow. The clock slave-MG uses the RTP timestamp to detect noncontiguous, that is, lost or out of sequence RTP packets. If a noncontiguous RTP packet is detected in the “Running” state, the clock slave-MG discards all packet sync. counter readings and reenters the “Initial” state.

Once in the “Done” state (block 58), the clock slave-MG continues to receive RTP packets that contain clock synchronization information from the clock master-MG. The clock slave-MG continues to record the value of the packet sync. counter when each RTP packet is received. Once 20 RTP packets have been received, the clock slave-MG computes the average of the values of the packet sync. counter. This average is used for informational purposes only.

While in the “Running” state, the MG computes an adjustment factor based upon the difference of the baseline and current averages. The adjustment factor is calculated as: AF=Interval*PSPPS/delta, where Interval=number of seconds elapsed between when the current and baseline averages were computed, PSPPS=packet sync pulses per second, a constant, and Delta=absolute value of the difference between the current and baseline averages. The adjustment factor is a dimensionless number that is written to a register in the FPGA. If the current average is larger than the baseline average, then the FPGA must shorten the period of the timing interval. If the current average is less than the baseline average, then the FPGA must lengthen the period of the timing interval. The FPGA contains another register that contains a direction bit that indicates whether the FPGA must shorten or lengthen the packet sync interrupt period.

The correction factor algorithm has two constraints placed upon it. First, Delta must be larger than 40. This protects against prematurely exiting the “Running” state when the difference between the master and slave clock frequencies is small. Second, the state machine must remain in the “Running” state for at least 240 seconds. This protects against prematurely exiting the “Running” state when the difference between the master and slave clock frequencies is large.

While a specific embodiment of the invention has been shown and described, it is to be understood that numerous changes and modifications may be made therein without departing from the scope and spirit of the invention as set forth in the appended claims.

1. A method of synchronizing the clocks of a plurality of media gateways used in an IP network, with at least one media gateway being connected to at least one PSTN, where each media gateway utilizes a clock that generates clock signals used for sampling, said method comprising:
(a) utilizing at least one PSTN clock as the source for synchronizing the clock signals of the clocks of at least one other of said plurality of media gateways;
(b) said step (a) comprising using at least one PSTN clock as the clock of at least one media gateway connected to at least one PSTN whereby the at least one media gateway connected to at least one PSTN serves as a master media gateway for at least one other of said plurality of media gateways;
(c) said step (a) further comprising broadcasting a network clock-synchronization packet from the master media gateway connected to at least one PSTN to at least one other media gateway which serves as a slave media gateway; and
(d) the at least one slave media gateway adjusting the clock thereof to match the clock of the master media gateway in order to synchronize the clock signals thereof with those of the master media gateway.

2. The method according to claim 1, wherein said step (c) comprises broadcasting a low-frequency network synchronization packet to the slave media gateways.

3. The method according to claim 1, wherein said step (c) comprises broadcasting a network clock-synchronization packet every second.

4. The method according to claim 1, wherein said step (d) comprises counting the number of internally-generated frame synchronization pulses over a period of time marked by the network clock-synchronization packet, then comparing that number with that of its own clock, and adjusting the clock signals generated by its own clock to match that of the master media gateway.

5. The method according to claim 1, wherein said step of adjusting the clock comprises:
originally recording the value of a frame synchronization counter immediately following the reception of a network synchronization packet;
comparing the current value of each subsequent network synchronization packet to that originally recorded and determining the difference therebetween; and
upon reaching a preset threshold value, adjusting the clock of the slave media gateway.

6. The method according to claim 5, wherein, upon reaching a preset threshold value, said step of adjusting the clock of the slave media gateway comprises:
writing to an Adjust Register the Adjust Factor (AF) value as determined as
$$AF = \frac{NFS}{128} ,$$
where NFS is the Number of Frame Synchronizations before correction defined by
$$NFS = \frac{T \times 8000}{D} ,$$
where D is the difference between the reference count and the current count, and where T is the time between the reference count and the current count.

7. The method according to claim 6, wherein, if a clock of a said slave media gateway is slow compared to that of a master media gateway, said step of adjusting the clock of a said slave media gateway comprises speeding up the clock of the said slave media gateway by setting D=|D|−1.

8. The method according to claim 1, wherein said step (d) comprises computing an adjustment factor AF, where AF=Interval*PSPPS/delta, where Interval=number of seconds elapsed between when current and baseline averages, where the baseline average is determined by averaging initially-received RTP packets that contain clock synchronization information from the at least one master media gateway clock, and where the current average is the average of a specified number of contiguous RTP packets received from said at least one media gateway clock, and where PSPPS=packet sync pulses per second, and where Delta=absolute value of the difference between the current and baseline averages.

9. The method according to claim 8, wherein, if the current average is larger than the baseline average, said step (d) shortening the period of the timing interval of said clock of the at least one slave media gateway; and, if the current average is less than the baseline average, said step (d) lengthening the period of the timing interval of said clock of said at least one slave media gateway.

10. The method according to claim 8, wherein Delta is greater than 40.

11. In an IP network comprising a plurality of media gateways with at least one said media gateway being connected to at least one PSTN via an interface, each said media gateway utilizing a clock that generates clock signals used for sampling, a method of synchronizing the clocks of said plurality of media gateways comprising:
(a) using at least one PSTN clock as the master clock of said at least one media gateway connected to at least one PSTN via an interface, whereby the at least one media gateway connected to at least one PSTN serves as a master media gateway for the other of said series of media gateways;
(b) broadcasting a network clock-synchronization packet from the master media gateway of said step (a) to at least one other media gateway which serves as at least one slave media gateway; and
(c) said at least one slave media gateway adjusting the clock thereof to match the clock of the master media gateway in order to synchronize the clock signals thereof with those of the master media gateway.

12. The method according to claim 11, wherein each media gateway is comprised of a Field Programmable Gate Array (FPGA) for controlling the synchronization of the clock pulses of a said media gateway, said step (c) comprising: writing to an Adjust Register of the FPGA the Adjust Factor (AF) value as determined as
$$AF = \frac{NFS}{128} ,$$
where NFS is the Number of Frame Synchronizations before correction defined by
$$NFS = \frac{T \times 8000}{D} ,$$
where D is the difference between the reference count and the current count, and where T is the time between the reference count and the current count.

13. The method according to claim 11, wherein, if a clock of a said slave media gateway is slow compared to that of a master media gateway, said step of adjusting the clock of a said slave media gateway comprises speeding up the clock of the said slave media gateway by setting D=|D|−1.

14. The method according to claim 11, wherein said step (c) comprises computing an adjustment factor AF, where AF=Interval*PSPPS/delta, where Interval=number of seconds elapsed between when current and baseline averages, where the baseline average is determined by averaging initially-received RTP packets that contain clock synchronization information from the at least one master media gateway clock, and where the current average is the average of a specified number of contiguous RTP packets received from said at least one media gateway clock, and where PSPPS=packet sync pulses per second, and where Delta=absolute value of the difference between the current and baseline averages.

15. The method according to claim 14, wherein, if the current average is larger than the baseline average, said step (c) shortening the period of the timing interval of said clock of the at least one slave media gateway; and, if the current average is less than the baseline average, said step (d) lengthening the period of the timing interval of said clock of said at least one slave media gateway.

16. A method of synchronizing the clock of a media gateway used in an IP network that comprises a plurality of media gateways where at least one media gateway is connected to at least one PSTN via an interface, said comprising:
(a) utilizing at least one PSTN clock as the source for synchronizing the clock signals of the clock of the media gateway with the IP network sending network clock-synchronization packets to the media gateway;
(b) synchronizing the clock of the media gateway;
(c) said step (b) comprising originally recording the value of a frame synchronization counter immediately following the reception of a network synchronization packet, comparing the current value of subsequent network clock-synchronization packets to that originally recorded, and determining the difference therebetween, and upon reaching a preset threshold value, adjusting the clock of the media gateway.

17. The method of synchronizing the clock of a media gateway according to claim 16, wherein said step of adjusting the clock comprises writing to an Adjust Register the Adjust Factor (AF) value as determined as
$$AF = \frac{NFS}{128} ,$$
where NFS is the Number of Frame Synchronizations before correction defined by
$$NFS = \frac{T \times 8000}{D} ,$$
where D is the difference between the reference count and the current count, and where T is the time between the reference count and the current count.

18. The method according to claim 16, wherein said step (b) comprises computing an adjustment factor AF, where AF=Interval*PSPPS/delta, where Interval=number of seconds elapsed between when current and baseline averages, where the baseline average is determined by averaging initially-received RTP packets that contain clock synchronization information from the at least one master media gateway clock, and where the current average is the average of a specified number of contiguous RTP packets received from said at least one media gateway clock, and where PSPPS=packet sync pulses per second, and where Delta=absolute value of the difference between the current and baseline averages.

19. The method according to claim 18, wherein, if the current average is larger than the baseline average, said step (c) shortening the period of the timing interval of said clock of the at least one slave media gateway; and, if the current average is less than the baseline average, said step (d) lengthening the period of the timing interval of said clock of said at least one slave media gateway.

20. The method according to claim 19, wherein Delta is greater than 40.
